(19) United States
(12) Patent Application Publication
(10) Pub. No.: US 2008/0066078 A1
(43) Pub. Date: Mar. 13, 2008

(54) METHOD AND SYSTEM FOR WEB-BASED OPERATING ENVIRONMENT

(75) Inventors: Nishit Rathod, Los Angeles, CA (US); Brandon Hance, Los Angeles, CA (US); Aaron Wiener, Los Angeles, CA (US)

Correspondence Address: SCHWEGMAN, LUNDBERG & WOESSNER, P.A., P.O. BOX 2938, MINNEAPOLIS, MN, 55402, US

(73) Assignee: Inhance Media, Inc.

(21) Appl. No.: 11/768,848

(22) Filed: Jun. 26, 2007

Related U.S. Application Data
(60) Provisional application No. 60/816,359, filed on Jun. 26, 2006.

(51) Int. Cl. G06F 9/44

(52) U.S. Cl. 719/311

(57) ABSTRACT

Embodiments of methods and systems for a web-based operating environment are described. A web-based operating environment of a web site may be accessed. The web-based operating environment may be loaded within a single instance of a web browser. The web site may include a plurality of available applications identified by a profile. At least one selected application of the plurality of available applications may be run within the web-based operating environment.

### PRIORITY CLAIM

This application claims the priority benefit of U.S. Provisional Application No. 60/816,359, filed 26 Jun. 2006, which is incorporated herein by reference.

### BACKGROUND

Graphical user interfaces (GUIs) provide an interface through which textual and/or graphical information is presented to a user. One type of GUI is synonymous with an electronic or computer “desktop” that is used to portray file systems and processes. Such a desktop, facilitated by the operating system, can include pictures (e.g., icons) that show cabinets, files, folders, and various types of documents (e.g., letters, reports, pictures and the like). A user can arrange the icons on the electronic desktop just as they can arrange real objects on a real desktop, e.g., by moving them around, putting one on top of another, reshuffling them, and throwing them away. The desktop is one aspect of conventional, graphical, windowed operating systems that enable computer users to obtain simultaneous or substantially simultaneous access to multiple applications running on a personal computer (PC).

By way of an example, the WINDOWS operating system by Microsoft Corporation provides such a type of desktop or GUI that runs on the majority of PCs worldwide. Apple Computer also provides its own graphical, windowed computer environment (referred to as the MAC OS) that also allows users to simultaneously or substantially simultaneously access multiple applications running on their PC. For each of these and other like operating systems, users can install and run applications locally on their PC and configure their environment to suit their particular needs. However, to upgrade to new versions of existing applications or to install new applications altogether, computer users generally have to purchase the new version or application, install the new software locally on their PC, and then configure their system appropriately. Such maintenance and upkeep of an individual's computer can be time-consuming and costly, as well as difficult for those not adept at computer administration.

### BRIEF DESCRIPTION OF THE DRAWINGS

Some embodiments are illustrated by way of example and not limitation in the figures of the accompanying drawings in which:

FIG. 1 is a block diagram of a system for providing access to a web site, according to an example embodiment;

FIGS. 2-5 are block diagrams of an example management application that may be deployed within the system of FIG. 1 according to an example embodiment;

FIG. 6 is a flowchart illustrating a method for running an application according to an example embodiment;

FIG. 7 is a flowchart illustrating a method for launching a selected application according to an example embodiment;

FIG. 8 is a flowchart illustrating a method for processing application data according to an example embodiment;

FIG. 9 is a flowchart illustrating a method for running an application according to an example embodiment;

FIG. 10 is a flowchart illustrating a method for event broadcasting according to an example embodiment;

FIG. 11 is a flowchart illustrating a method for processing an event according to an example embodiment;

FIG. 12 is a flowchart illustrating a method for receiving application data according to an example embodiment;

FIG. 13 is a flowchart illustrating a method for communicating with a target application according to an example embodiment;

FIG. 14 is a flowchart illustrating a method for running an instance of an application according to an example embodiment;

FIG. 15 is a flowchart illustrating a method for moving an item on a desktop according to an example embodiment;

FIG. 16 is a block diagram of a desktop according to an example embodiment;

FIG. 17 is a flowchart illustrating a method for utilizing the web-based operating environment as a platform for a social networking market according to an example embodiment;

FIG. 18 is a block diagram of a data structure used to track an application in the web-based operating environment of FIG. 1; and

FIG. 19 is a block diagram diagrammatic representation of machine in the example form of a computer system within which a set of instructions for causing the machine to perform any one or more of the methodologies discussed herein may be executed.

### DETAILED DESCRIPTION

Example methods and systems for web-based operating environment are described. In the following description, for purposes of explanation, numerous specific details are set forth in order to provide a thorough understanding of example embodiments. It will be evident, however, to one skilled in the art that the present invention may be practiced without these specific detail

In an example embodiment, a web-based operating environment of a web site may be accessed. The web-based operating environment may be loaded within a single instance of a web browser. The web-based operating environment may include a plurality of available applications identified by a profile. At least one selected application of the plurality of available applications may be run within the web-based operating environment.

In an example embodiment, a launch request for an application of a web site may be received in a web-based operating environment. An instance of an application window may be created in the web-based operating environment. At least one initialization parameter may be provided to the instance of the application window. The application may be loaded in the application window. The application may be initialized within the application window in accordance with the at least one initialization parameter to run the application.

In an example embodiment, a notification and at least one parameter may be received from an application running within a web-based operating environment. The notification may be identified as an event. The event and the at least one parameter may be broadcast to a plurality of applications running within the web-based operating environment of a web site.

In an example embodiment, a request for application data for an application may be received. The application may be available within a web-based operating environment of a web site. The request for the application data may be sent to a back-end server. The application may be frozen and a progress indicator may be displayed on the desktop in the web-based operating environment. The frozen application may be configured to ignore a further received request. The application data may be received from the back-end server. The frozen application may be unfrozen and the display of the progress indicator may be removed upon receipt of the application data.

In an example embodiment, an identification of a target application and at least one target parameter may be received. The target application may be available within a web-based operating environment of a web site. A determination of whether an instance of the target application is running in the web-based operating environment may be performed. A new instance of the target application may be created based on a result of the determination. The at least one target parameter may be provided to the target application based on the result of the determination.

In an example embodiment, a drag request may be received for an item on a desktop within a web-based operating environment. The item may be associated with an item type. A drag image may be displayed for the item following a mouse cursor displayed on the desktop. The plurality of parameters may include the item type. A target application associated with a drop request may be identified. The plurality of parameters may be provided to the target application associated with the drop request. The target application may be capable of evaluating the item based on at least one of the plurality of parameters to determine a reaction.

In an example embodiment, a web-based operating environment of a web site may be accessed. The web-based operating environment may be capable of being loaded within a single instance of a web browser. A plurality of applications for the web-based operating environment may be associated according to a social networking market. An identification of the plurality of applications available in the web-based operating environment for the social networking market may be stored in a profile.

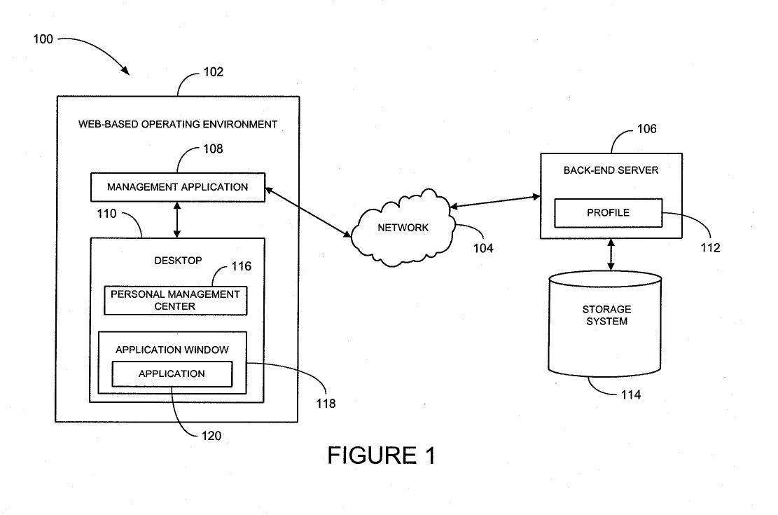

FIG. 1 illustrates a system 100 in which access to a web site may be accessible to a user through a web-based operating environment 102. For example, the web-based operating environment 102 may be presented to a user on a display of a computer system.

The web-based operating environment 102 may be available to the user in a single instance (e.g., a single window or tab) of a web browser. The web browser may include any suitable type of computer network or Web browser application that can be configured to view or otherwise access textual and/or graphical information, including multimedia information (e.g., sound and video), located on a computer network, such as, for example, Microsoft Corporation's INTERNET EXPLORER, Mozilla's FIRE FOX, Apple Computer's SAFARI, Netscape NAVIGATOR, Opera Software's OPERA, Mozilla's CAMINO, or any other appropriate type of Web browser or the like.

The web-based operating environment 102 may act as a platform for the web site. For example, instead of accessing a web site by receiving one or more pages from a back-end server, the functionality of the web site may be made available to the user through applications 120 available on the web-based operating environment 102. The applications 120 may run locally on the desktop 110 of a computing system of a user instead of running remotely on the back-end server, thereby enabling quicker response times, greater distribution of resources, and improved functionality.

The web-based operating environment 102 may include a management application 108 and a desktop 110. The desktop 110 may be a workspace (e.g., a graphical user interface) of the web-based operating environment 102, displayed within the web browser, through which a user may interact with the web-based operating environment 102. The desktop 110 may include a personal management center 116 and a number of application windows 118.

An application window 118 may be a graphical window displayed on the desktop 110 of the web-based operating environment 102 for presenting graphical and/or textual information to a user. The application window 118 may display any suitable textual and/or graphical content (including multimedia information, such as sound and video) to the user. The application window 118 may include a title bar, and icon, and functionality so that the user can move the application window 118 within the desktop 110. The application window 118 may be minimized, maximized, resized, closed, moved, or skinned. Application windows 118 may be scrollable (e.g., vertically and/or horizontally), when desired, for viewing the information contained within the entirety of the application window 118. For example, the application window 118 may be used to display the results of a selection or request for information. Application windows 118 may be stacked on top of each other, and the active application window 118 may be on top or in front of the application window(s) 118 that it shares space with on the desktop 110.

Through the application windows 118, a user may run an application 120 and interact with the web-based operating environment 102. Application windows 118 may include any dynamic or static display of information to a user, and may be interactive. For example, according to an example embodiment, a particular application window 118 may be substantially static (e.g., the information displayed on the application window 118 changes infrequently, such as, for example, the presentation of a simple list of items) and be less interactive than an application 120.

The application 120 may be displayed within the application window 118 presented on the desktop 110. The application 120 supports functionality in the web-based operating environment 102 and may be fully or partially interactive to allow a user to access the functionality supported by the application 120. For example, a particular application 120 may include a web site design application, a digital music player, an instant messenger, an e-mail program, a file system, a shopping cart, a blogging program, a music listing (e.g., corresponding to a music player application), a photo or photo album, a scrapbook, a “buddy” list (e.g., corresponding to an instant messenger application), a video or other desired applications. The application 120 may be a SWF file, a java script file (e.g., AJAX), a graphic image file (JPEG), or other type of file.

The applications 120 in the web-based operating environment 102 may be integrated so that the actions or choices taken by a user in a first application 120 of the web-based operating environment 102 may have an effect on a second application 120 of the web-based operating environment 102. The applications 120 may be in an application framework where the various applications 120 communicate among one another.

The application 120 may send and/or receive application data to other applications in the web-based operating environment 102 and/or the back-end server 106. The application data may include any content that is consumed or used by the application 120. For example, the application data may come from a user; from a user as modified by a particular application 120, and/or provided by the system itself (e.g. from the storage system 114). The application 120 may store application data client side and/or server side.

The applications 120 available to the web-based operating environment 102 may be based on a profile 112 available with the back-end server 106 and available over the network 104. The profile 112 may enable a user to log in to the web site with a user name or password or may be anonymous or a guest (e.g., with limited functionality provided). The profile 112 may optionally be stored in the storage system 114.

A personal management center 116 may be available on the desktop 110 to enable profile management for the user. For example, content may be updated using the personal management center 116 that may be reflected in the profile 112.

The personal management center 116 may include user centered applications 120 available to one or more different types of profiles 112. For example, a tool in the personal management center 116 may be used to update the profile 112 of a user and may be reflected in the profile information of the user. The personal management center 116 may also be used to manage, for example, music information, items being sold in the stored, a calendar (e.g., with private and public entries), sales reporting, and the like.

The profile 112 may include information and functionality available from available applications 120 to the user and other users through the web site. The functionality available may be based on the applications 120 available to the user and/or the applications 120 selected by the user for association with the profile 112. The applications 120 that are loaded may be dependent on the settings as configured by the user. The profile 112 may retain preferences of the user and may be modified by the actions of one or more of the applications 120 within the web-based operating environment 102.

A portion of the profile 112 may be publicly available to other users of the web site. A portion of the profile 112 may be restricted to certain users in the of the web site. A portion of the profile may only be available to the user. Users may browse profiles of other users, while listening to music, designing t-shirts, and/or performing other actions within the web-based operating environment 102.

The network 104 may be a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The management application 108 may manage the applications 120 in the web-based operating environment 102 (e.g., as may be available on the desktop 110). The management application 108 may load and run the applications 120 within the web-based operating environment 102 and keep track of the various applications 120.

The storage system 114 may retain data and may be made available to the application 120 and/or the management application 108 through the back-end server 106. The storage system 114 may include a database to retain the data.

The web-based operating environment 102 may be customized by a user for interaction and may be dynamic and/or context sensitive based on a user that is using the web-based operating environment 102 of a web site.

The web-based operating environment 102 may be a multi-tasking environment capable of running and providing multiple applications 120 simultaneously (e.g., simultaneously or substantially simultaneous) in a single user interface (e.g., the desktop 110) of the single instance of the browser. The web-based operating environment 102 may be used, by way of an example, for a social networking market where there are one-to-many relationships.

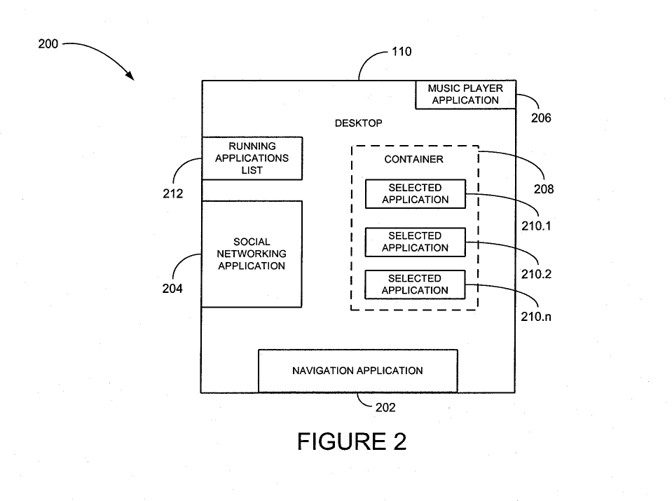

FIG. 2 illustrates an example system 200 in which the desktop 110 (see FIG. 1) is shown to include a number of applications. The desktop 110 may include a navigation application 202, a social networking application 204, a music player application 206, a container 208 and/or one or more selected applications 210.1-210.n. Other applications may also be present on the desktop 110.

The navigation application 202, the social networking application 204, and/or the music player application 206 may be on a top layer in the web-based operating environment 102 and the container 208 may be on a bottom layer in the web-based operating environment 102. However, other applications may be included in the top layer so that they automatically run upon user login. The applications contained in the top layer may be hidden and become available when a user directs a mouse cursor with the location of the application window 118 of the application. The layers may be based on the programming language in which the web-based operating environment 102 is created (e.g., FLASH) or may be otherwise implemented in the web-based operating environment 102.

The various applications in the web-based operating environment 102 may communicate with other applications by broadcasting notifications (e.g., events) generally to other applications or application chaining (e.g., sending information or requests directly to a specific target application).

The navigation application 202 may be used to run a selected application 210 in the web-based operating environment 102 as selected by the user.

The social networking application 204 may enable communication among users of the web site and may include, by way of an example, an instant messaging (IM) application with a buddy list. The social networking application 204 may enable items to be shared among various users of the web site.

In an example embodiment, the navigation application 202, the social networking application 204, and the music player application 206 may be running in the web-based operating environment 102 prior to the selected applications 210.1-210.n. The container 208 may house all selected applications 210.1-210.n within the web-based operating environment 102 and may cover the entire portion of the desktop 110.

A running applications list 212 may be used by the management application 108 (see FIG. 1) to keep track of running applications and provide applications for running and messaging applications. The running applications lists 212 may be visible or invisible to the user of the desktop 110.

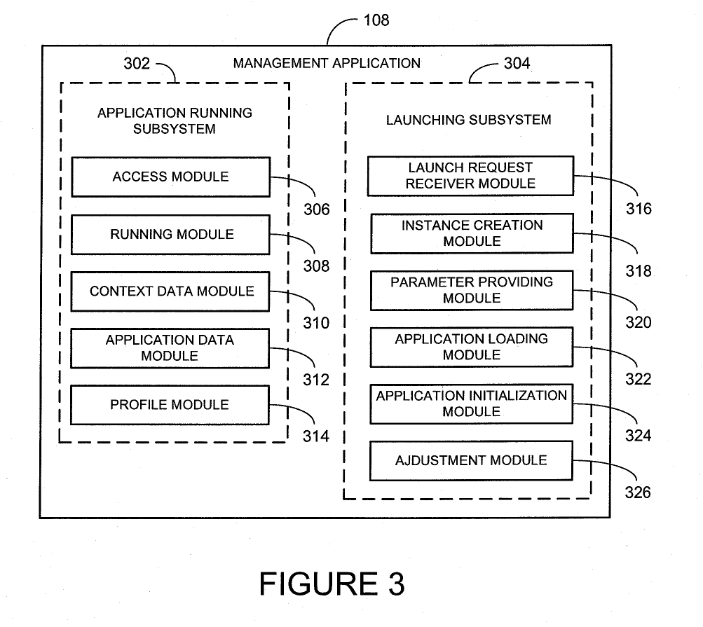

FIG. 3 is an example of the management application 108 that may be deployed in the system 100 (see FIG. 1) or another system according to an example embodiment. The management application 108 may include an application running subsystem 302 and/or a launching subsystem 304. Other subsystems may also be used.

The application running subsystem 302 may include an access module 306, a running module 308, a context data module 310, an application data module 312, and/or a profile module 314. Other modules may also be used.

The access module 306 accesses the web-based operating environment 102 of a web site. The web-based operating environment 102 may include available applications identified by a profile. The running module 308 runs a selected application 120 of the available applications 120 within the web-based operating environment 102.

The context data module 310 provides context data from the selected application to at least one available application 120 to enable application chaining. The context data may be data originating from a first application that is provided to a second application that may be relevant to the operations of the second application.

The application data module 312 receives application data from the selected application 120 and stores the application data. The profile module 314 receives a profile modification request and modifies the profile 112 of a user of the web-based operating environment 102 in accordance with the profile modification request.

The launching subsystem 304 may include a launch request receiver module 316, an instance creation module 318, a parameter providing module 320, an application loading module 322, an application initialization module 324, and/or an adjustment module 326. Other modules may also be used.

The launch request receiver module 316 receives a launch request for an application 120 in the web-based operating environment 102 of a web site. The instance creation module 318 creates an instance of the application window 118 in the web-based operating environment 102.

The parameter providing module 320 providing at least one initialization parameter to the instance of the application window 118. The application loading module 322 loads the application in the application window 118.

The application initialization module 324 initializes the application 120 within the application window 118 in accordance with the at least one initialization parameter to run the application 120. The adjustment module 326 receives an adjustment request for the application window 118 and adjusts the application window 118 in accordance with the adjustment request.

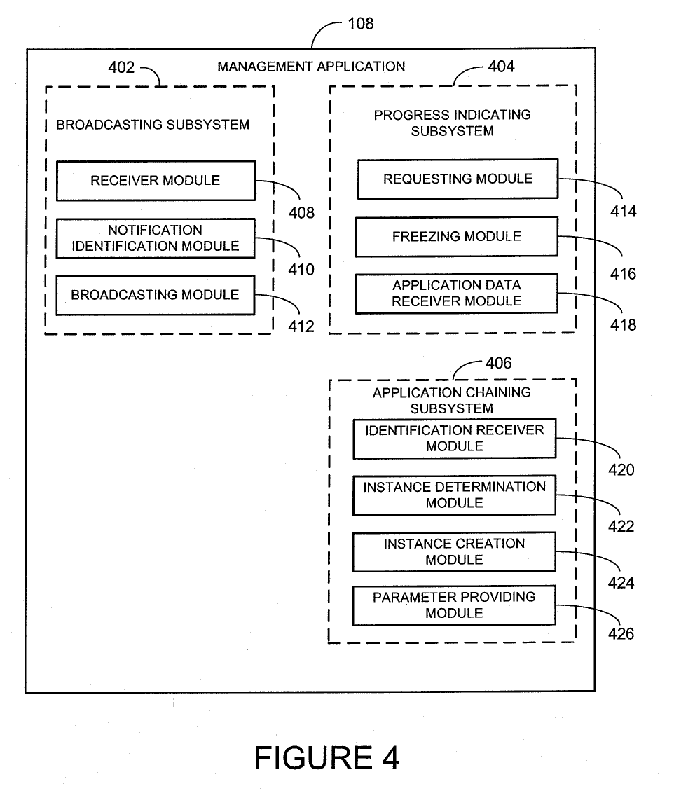

FIG. 4 is an example of the management application 108 that may be deployed in the system 100 (see FIG. 1) or another system according to an example embodiment. The management application 108 may include a broadcasting subsystem 402, a progress indicating subsystem 404, and/or an application chaining subsystem 406. Other subsystems may also be used.

The broadcasting subsystem 402 may include a receiver module 408, a notification identification module 410, and/or a broadcasting module 412. Other modules may also be used.

The receiver module 408 receives a notification and a parameter from an application 120 running within the web-based operating environment 102. The notification identification module 410 identifies the notification as an event. The broadcasting module 412 broadcasts the event and the parameter to applications 120 running on the desktop 110 of the web-based operating environment of a web site.

The progress indicating subsystem 404 may include a requesting module 414, a freezing module 416, and/or an application data receiver module 418. Other modules may also be used.

The requesting module 414 receives a request for application data for an application available within a web-based operating environment of a web site and/or sends the request for the application data to the back-end server 106.

The freezing module 416 freezes the application 120 and displays a progress indicator and/or unfreezes the frozen application 120 and removes display of the progress indicator upon receipt of application data.

The application data receiver module 418 receives the application data from the back-end server 106.

The targeting subsystem 406 may include an identification receiver module 420, an instance determination module 422, an instance creation module 424, and/or a parameter providing module 426. Other modules may also be used.

The identification receiver module 420 receives an identification of a target application 120 and at least one target parameter. The target application 120 may be running on the desktop 110 of the web-based operating environment 102.

The instance determination module 422 determines whether an instance of the target application is running in the web-based operating environment 102 and/or whether the target application is configured to have multiple instances running in the web-based operating environment 102.

The instance creation module 424 creates a new instance of the target application 120 based on a result of the determination. The parameter providing module 426 provides the at least one target parameter to the target application 120 based on the result of the determination.

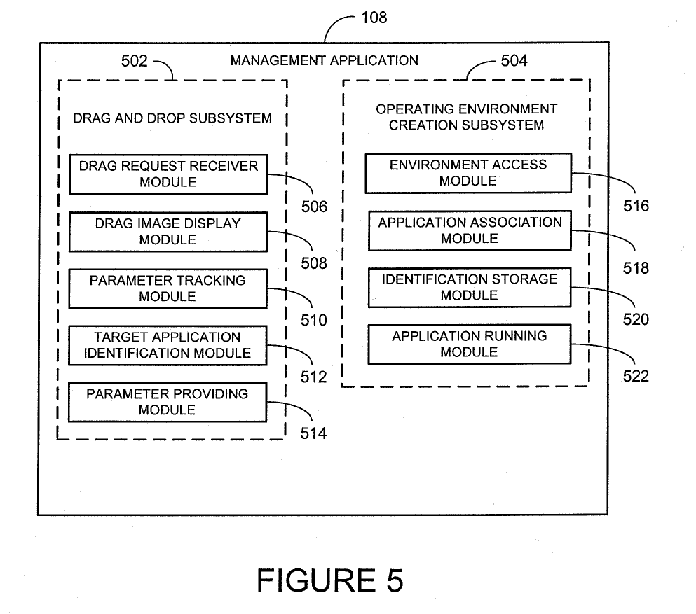

FIG. 5 is an example of the management application 108 that may be deployed in the system 100 (see FIG. 1) or another system according to an example embodiment. The management application 108 may include a drag and drop subsystem 502 and/or an operating environment creation subsystem 504. Other subsystems may also be used.

The drag and drop subsystem 502 may include a drag request receiver module 506, a drag image display module 508, a parameter tracking module 510, a target application identification module 512, and/or a parameter providing module 514. Other modules may also be used.

The drag request receiver module 506 receives a drag request for an item on the desktop 110. The drag image display module 508 displays a drag image for the item following a mouse cursor displayed on the desktop 110 within the web-based operating environment 102.

The parameter tracking module 510 tracks parameters (e.g., item type) of the item in the web-based operating environment 102. The target application identification module 512 identifies a target application 120 associated with a drop request.

The parameter providing module 514 provides the parameters to the target application 120 associated with a drop request. The target application 120 may be capable of evaluating the item based on at least one of the parameters to determine a reaction.

The operating environment creation subsystem 504 may include an environment access module 516, an application association module 518, an identification storage module 520, and/or an application running module 522. Other modules may also be used.

The environment access module 516 accesses the web-based operating environment 102 of a web site. The application association module 518 associates multiple applications 120 for the web-based operating environment 102 according to a social networking market.

The identification storage module 520 stores identification of the applications available in the web-based operating environment 102 in the profile 112. The application running module 522 runs a selected application of the plurality of applications 120 of the web-based operating environment 102.

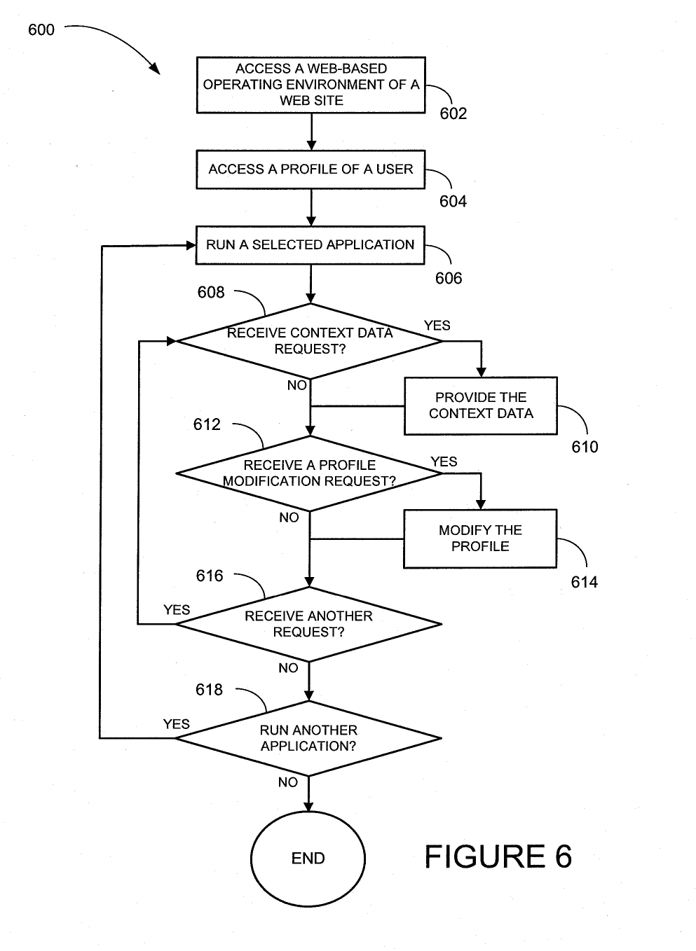

FIG. 6 illustrates a method 600 for running an application according to an example embodiment. The method 600 may be performed by the management application 108 (see FIG. 1) as deployed in the system 100 or in a different system. For example, the method 600 may be performed after a user logs into a web site as an existing user, a new user, a guest user, and/or anonymously.

A web-based operating environment 102 of a web site is accessed at block 602. Each user of the web site may be provided with a web-based operating environment 102 with which the user can use to communicate with the web site and other users of the web site. The web-based operating environment 102 may be loaded within a single instance of a web browser of the user and may include available applications identified by the profile 112.

In an example embodiment, the web-based operating environment 102 may be loaded within a web page and the applications may be loaded within the web-based operating environment 102. For example, an OS loader may retrieve one or more parameters (e.g., a session ID), preload an operating environment application (e.g., a SWF file), and pass an initialization parameter to an operating environment application to run the web-based operating environment 102 of the web site.

The profile of a user of the web-based operating environment 102 may be accessed at block 604.

At least one selected application of the available applications 120 is run within the web-based operating environment 102 at block 606. The selection of the at least one selected application to be run may be based on the profile 118. The at least one selected application may be run client-side or server-side.

In an example embodiment, running the at least one selected application may include running multiple selected applications simultaneously within the web-based operating environment 102.

A determination may be made at decision block 608 as to whether a context data request has been received. If a determination is made that context data has been received, at block 610 context data may be provided from the at least one selected application to at least one available application (e.g., capable of utilizing the context data). The at least one available application may be running or not running within the web-based operating environment at the time the context data is received by the at least one available application. If a determination is made at decision block 608 that a context data request has not been received or upon completion of the operations at block 610, the method 600 may proceed to decision block 612.

At decision block 612, a determination may be made whether a profile modification request has been received. The profile modification may include, by way of an example, a request to modify the plurality of available applications 120 available within the web-based operating environment 102, a portion of the profile 112 to display to other users of the web site, user information of a user of the web-based operating environment 102, or a combination thereof.

If a determination is made that the profile modification request has been received, at block 614 the profile 112 of the user of the web-based operating environment 102 may be modified in accordance with the profile modification request. If a determination is made at decision block 612 that a profile modification request has not been received or upon completion of the operations at block 614, the method 600 may proceed to decision block 616.

A determination may be made at decision block 616 as to whether another request may be received. If a determination is made that another request may be received, the method 600 may return to decision block 608. If a determination is made at decision block 616 that another request may not be received, the method 600 may proceed to decision block 618.

At decision block 618, a determination may be made whether to run another application. If a determination is made to run another application, the method 600 may return to block 606 or block 604. If a determination is made not to run another application at decision block 618, the method 600 may terminate.

The operations at decision block 608 and decision block 612 may occur in any order. The operations at decision block 616 and decision block 618 may occur in any order.

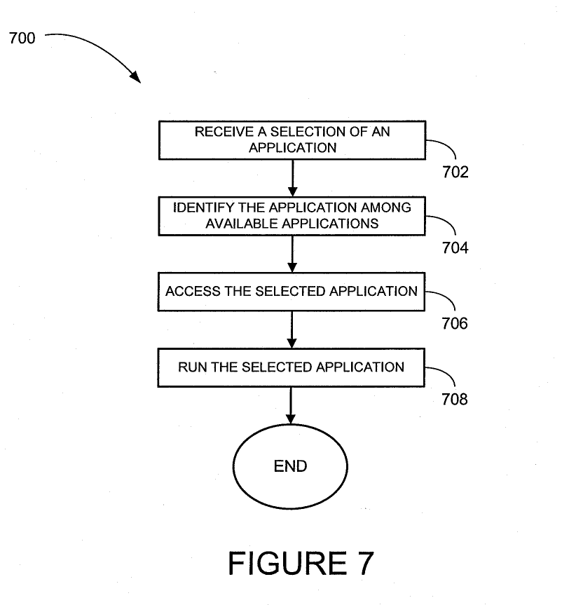

FIG. 7 illustrates a method 700 for launching a selected application (e.g., the application 120) according to an example embodiment. The method 700 may be performed by the management application 108 (see FIG. 1) as deployed in the system 100 or in a different system.

A selection of at least one application is received at block 702. At block 704, the at least one selected application is identified among the plurality of available applications within the web-based operating environment.

The at least one selected application is accessed at block 706. The at least one selected application is run within the web-based operating environment 102 at block 708.

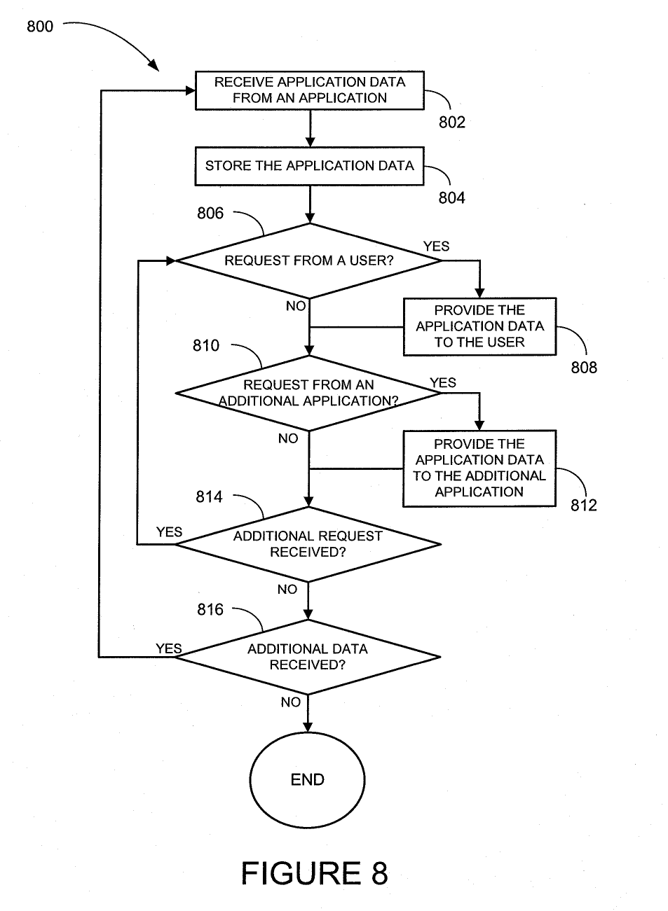

FIG. 8 illustrates a method 800 for processing application data according to an example embodiment. The method 800 may be performed upon completion of the operations at block 606, decision block 618, block 708 or otherwise performed.

Application data is received from an application (e.g., at least one selected application) at block 802. The application data may be stored (e.g., client-side or server-side) at block 804.

A determination may be made at decision block 806 as to whether a request for application data has been received from a user. If a determination is made that a request has been received from the user, the application data may be provided to the user (e.g., client-side) at block 808. The user may display the application data on the desktop 110 and/or store the application data locally. If a determination is made that a request has not been received from the user at decision block 806 or upon completion of the operations at block 808, the method 800 may proceed to decision block 810.

At decision block 810, a determination may be made as to whether a request for the application data from an additional application has been received. If a determination is made that a request has been received from the additional application, the application data may be provided to the additional application at block 812. If a determination is made that a request has not been received from the additional application at decision block 810 or upon completion of the operations at block 812, the method 800 may proceed to decision block 814.

A determination may be made at decision block 814 as to whether an additional request has been received. If a determination is made that an additional request has been received, the method 800 may return to decision block 806. If a determination is made that an additional request has not been received, the method 800 may proceed to decision block 816.

At decision block 816, a determination may be made as to whether additional data has been received. If a determination is made that additional data has been received, the method 800 may return to block 802. If a determination is made at decision block 816 that additional data has not been received, the method 800 may terminate.

The operations at decision block 806 and decision block 810 may occur in any order. The operations at decision block 814 and decision block 816 may occur in any order.

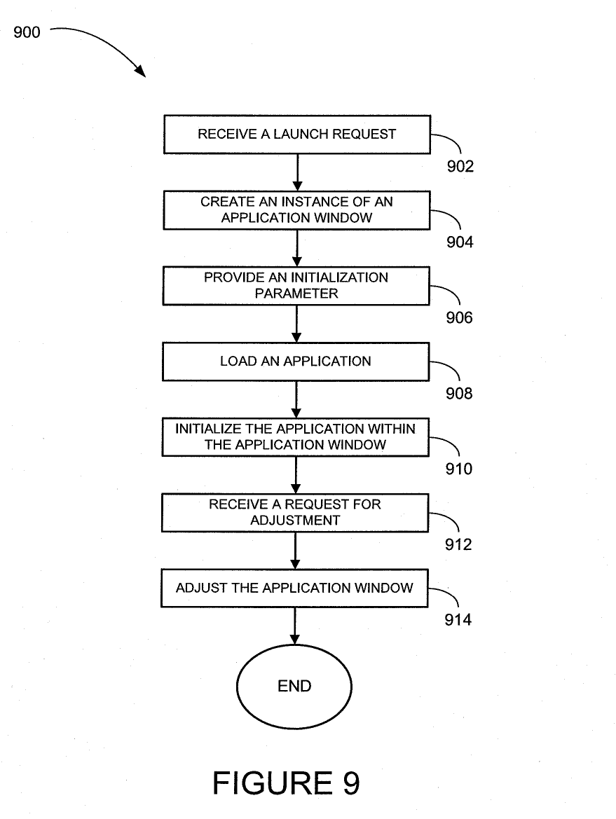

FIG. 9 illustrates a method 900 for running the application 120 according to an example embodiment. The method 900 may be performed at block 708 (see FIG. 7) and/or by the management application 108 (see FIG. 1) as deployed in the system 100 or in a different system.

A launch request is received for the application 120 of a web site in the web-based operating environment 102 at block 902. The application 120 may be the navigation application 202, the social networking application 204, the music player application 206, the container 208, the selected application 210, or another application. At least one initialization parameter may also be received with the launch request.

An instance of an application window 118 is created in the web-based operating environment for the desktop 110 at block 904. The application window 118 may be used to house the application 120 on the desktop 110 within the web-based operating environment 102.

At least one initialization parameter is provided to the instance of the application window 118 at block 906. The initialization parameter may include, by way of example, a file name or a file identifier (ID).

The application 120 is loaded in the application window 118 at block 908. The application may be a SWF file or another type of file.

The application 120 is initialized within the application window 118 in accordance with the at least one initialization parameter at block 910. Initializing the application 120 may cause the application 120 to run within the web-based operating environment 102. For example, a single parameter may be used to cause the application 120 to run and other parameters may be provided simultaneously or later provided to application 120 to cause a reaction (e.g., launch an e-mail in a messaging application).

An adjustment request for adjustment to the application window 118 may be received at block 912. The adjustment may include minimizing the application window 118, maximizing the application window 118, resizing the application window 118, closing the application window 118, moving the application window 118, and/or applying a skin to the application window 118. The adjustment to the application

In an example embodiment, the request for adjustment to the application window 11 8may be received, a recording of the application window 118 may be modified in accordance with the adjustment, and the adjustment may be provided to the application window 118.

The application window 118 may be adjusted in accordance with the adjustment request at block 914. The adjustment may include, for example, scaling the application window 118 in accordance with the adjustment request. The dimensions and/or an aspect ratio of the application window 118 may not change as a result of scaling.

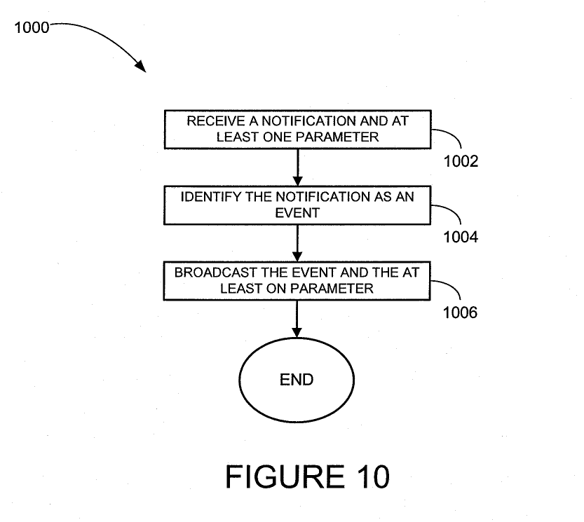

FIG. 10 illustrates a method 1000 for event broadcasting according to an example embodiment. The method 1000 may be performed by the management application 108 (see FIG. 1) as deployed in the system 100 or in a different system. By way of an example, the method 1000 may be used to notify the applications 120 in the web-based operating environment 102 of an event originating at a running application.

At block 1002, a notification (e.g., a user interaction or an application update) and at least one parameter is received from the application 120 running within the web-based operating environment 102. The at least one parameter may include, by way of an example, an event type, an initialization parameter, a session identifier (ID), a user name, and/or a user type.

The notification is identified as an event at block 1004. Example events include logging in or logging out of the web-based operating environment 102 of the web site.

At block 1006, the event and the at least one parameter is broadcast to applications 120 running on the desktop 110 within the web-based operating environment 102 of a web site.

In an example embodiment, the running applications list 212 may be accessed and the event and the at least one parameter may be broadcast to the applications 120 on the running applications list 212.

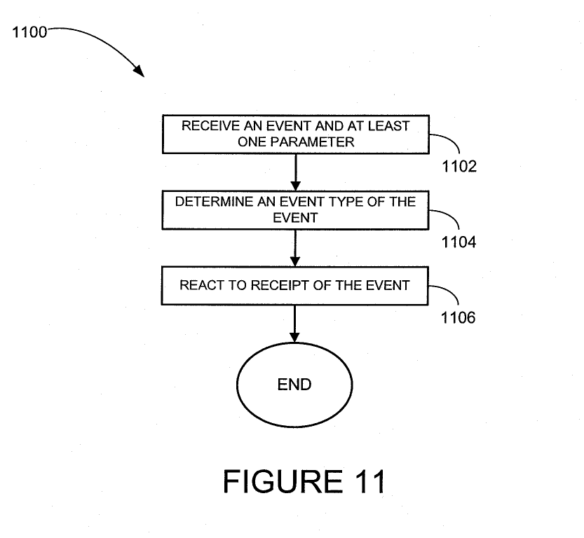

FIG. 11 illustrates a method 1100 for processing an event according to an example embodiment. The method 1100 may be performed by the application 120 (see FIG. 1) as deployed in the system 100 or in a different system.

At block 1102, an event and at least one parameter is received from the management application 108 in the web-based operating environment 102.

An event type of the event is determined from the at least one parameter at block 1104. The event type may include, for example, a log in event or a log out event.

A reaction is made to receipt of the event based on the event type at block 1106. The reaction may include modifying an attribute of the application 120 that receives the event. For example, the application 120 may react by changing appearance, may include availability of an additional item, and the like.

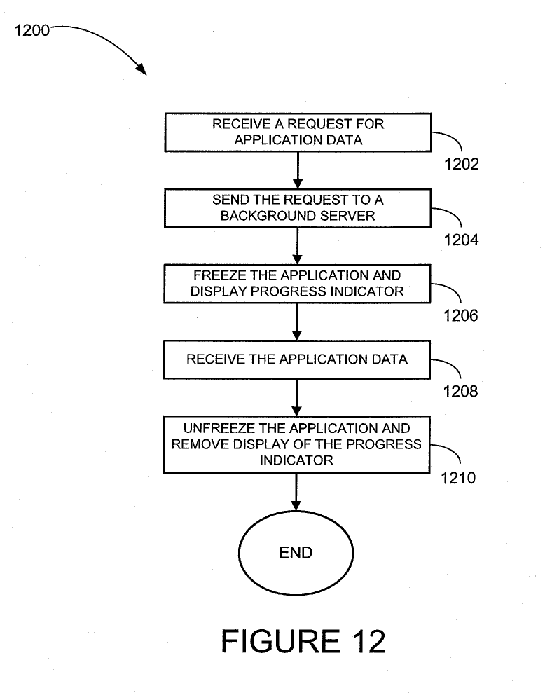

FIG. 12 illustrates a method 1200 for receiving application data according to an example embodiment. The method 1200 may be performed by the application 120 and/or the management application 108 (see FIG. 1) as deployed in the system 100 or in a different system. For example, the application 120 may freeze itself or may be frozen the management application 108.

By of an example, the method 1200 may be used to provide application data to the application 120 prior to running the application 120 within the web-based operating environment 102 when an amount and/or size of application data to be received may cause a delay. For example, the delay may occur when a user clicks a submit button and waits for application data to be received from the back-end server 106.

At block 1202, a request for application data is received for the application 120 available within the web-based operating environment 102 of a web site. The application data may include, by way of an example, search results or an image and may include a single item or multiple items. A counter may be incremented for each item of application data requested. The request for the application data is sent to a back-end server at block 1204.

The application 120 is frozen and a progress indicator is displayed on the desktop 110 at block 1206. The progress indicator may indicate the progress of the receiving of the application data. The application 120 when frozen may ignore any further received requests. The progress indicator may include a progress animation (e.g., a rotation of an image), a static image, or the like.

In an example embodiment, freezing the application 120 may include associating an invisible button with the frozen application 120. The invisible button may be configured to receive any further requests so that they are not passed through to the application 120 and processed.

The application data is received from the back-end server 106 at block 1208. The counter may be decremented for each item of application data received.

The frozen application 120 is unfrozen and the display of the progress indicator may be removed upon receipt of the application data at block 1210. For example, the operations at block 1210 may occur when the counter returns to a base number before adjustment. The invisible button may be deactivated during the operations at block 1210.

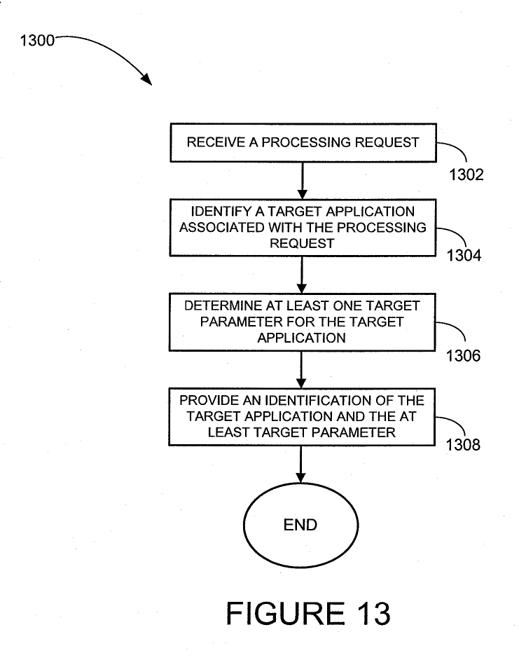

FIG. 13 illustrates a method 1300 for communicating with a target application (e.g. application 120) according to an example embodiment. The method 1300 may be performed by the application 120 (see FIG. 1) as deployed in the system 100 or in a different system. By way of an example, the method 1300 may enable information and/or processing requests to be passed between applications 120 through application chaining in the web-based operating environment 102.

A processing request may be received for a target application at block 1302. The processing request may be received from the user or another application in the web-based operating environment 102.

At block 1304, the target application 120 associated with the processing request may be identified on the desktop 110 of the web-based operating environment 102 of the web site. At least one target parameter may be determined for the target application 120 to process the processing request at block 1306.

An identification of the target application 120 and the at least one target parameter may be provided to the management application 108 (see FIG. 1) at block 1308.

By way of an example, the method 1300 may be used to send a message to another user of the web site. A user may select a buddy list on the social networking application 204 (see FIG. 2) and select the option of sending a message to the friend. The social networking application 204 may provide to the management application 108 a first parameter for a messaging application to create a new message and include the friend in the address list and a second parameter identifying the target application as the messaging application. A new message may then be created with the friend included in the address field.

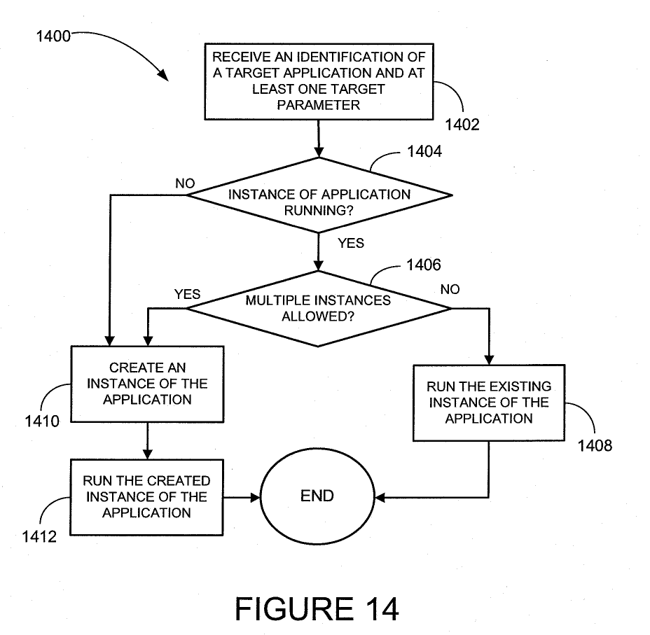

FIG. 14 illustrates a method 1400 for running an instance of an application 120 according to an example embodiment. The method 1400 may be performed by the management application 108 (see FIG. 1) as deployed in the system 100 or in a different system. By way of an example, the method 1400 may be used to determine whether information and/or a processing request may be provided an existing instance of the application 120 or whether a new instance of the application 120 is created to receive the information and/or the processing request.

An identification of an application 120 (e.g., a target application 120) and at least one target parameter may be received at block 1402.

A determination may be made at decision block 1404 as to whether an instance of an application is already running within the web-based operating environment 102. If a determination is made that an instance of the application 120 is not running, an instance of the application 120 may be created (e.g., within an application window 118) at block 1410 and the created instance may be run at block 1412. If a determination is made that an instance of the application 120 is running at decision block 1404, the method 1400 may proceed to decision block 1406.

At decision block 1406, a determination may be made as to whether multiple instances of the application 120 are allowed to run within the web-based operating environment 102. If a determination is made that multiple instances are allowed to run, the method 1400 may proceed to block 1410. If a determination is made at decision block 1406 that multiple instances of the application 120 are not allowed to run, the application 120 may be run in an existing instance at block 1408.

In an example embodiment, parameters may be passed to the instance of the application during the operations at block 1408 and/or block 1412.

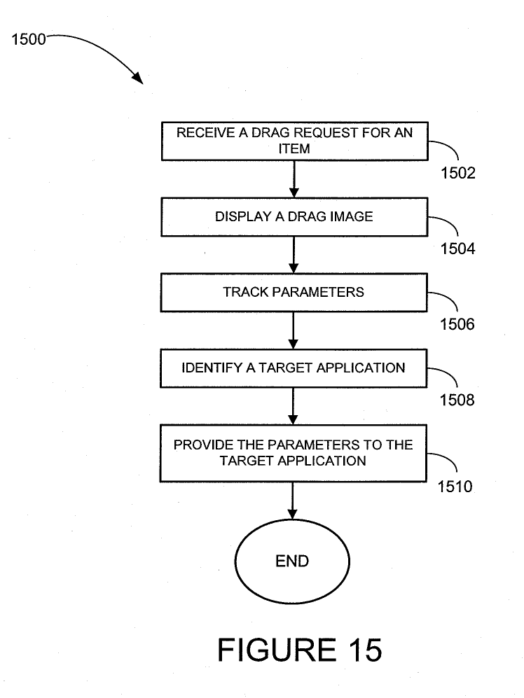

FIG. 15 illustrates a method 1500 for moving an item on the desktop 110 within the web-based operating environment 102 of a web site. The method 1500 may be performed by the management application 108 and/or the application 120 (see FIG. 1) as deployed in the system 100 or in a different system. By way of an example, the method 1500 may be used to share an item with another user of the web site.

A drag request is received for an item on the desktop 110 within the web-based operating environment 102 of a web site at block 1502. The item may be associated with an item type. The item may be contained in an application, be located on the desktop (e.g., as an image), or may otherwise be available in the web-based operating environment 102.

A drag image is displayed on the desktop 110 for the item and follows a mouse cursor displayed on the desktop 110 at block 1504. The drag image may be an image, animation, or other graphical representation that provides indicia that the item is being moved within the desktop 110 to the user. The draft image may include additional information (e.g., how many items are being moved).

Multiple parameters of the item may be tracked in the web-based operating environment 102 at block 1506. The multiple parameters may include, by way of example, the item type and a source of the item. The parameters may be stored in the drag image. A target application associated with a drop request is identified at block 1508.

The parameters are provided to the target application associated with a drop request at block 1510. The target application may be capable of evaluating the item based on at least one of the parameters to determine a reaction.

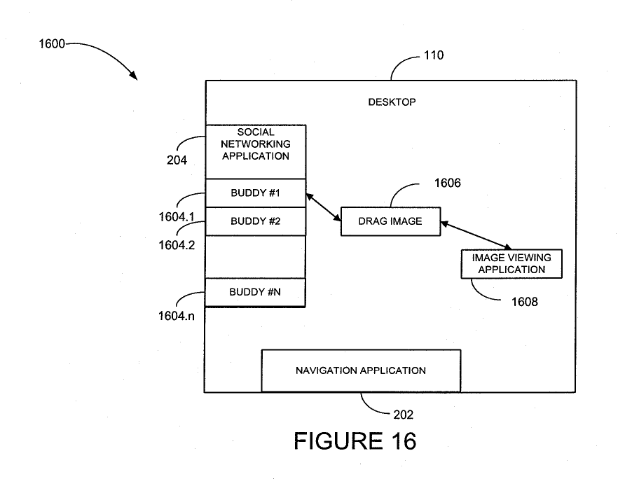

FIG. 16 illustrates an example web-based operating environment 102 in which the desktop 110 includes the navigation application 202 and the social networking application 204. The social networking application 204 may include a number of buddies 1604.1-1604.n on a buddy list 1604.

In an example embodiment, when a user starts dragging an item a drag started event may be triggered. A drag image may be associated with the item and the properties of the drag image are set. The drag image 1606 may be passed the reference of the item. The item may be released by the user on a target application. The properties of the drag image may be provided to the target application. Data regarding the item, target application, and action may be compiled and dispatched to a specialized drag and drop handler of the target application which may then respond to receiving the drag image and the associated properties.

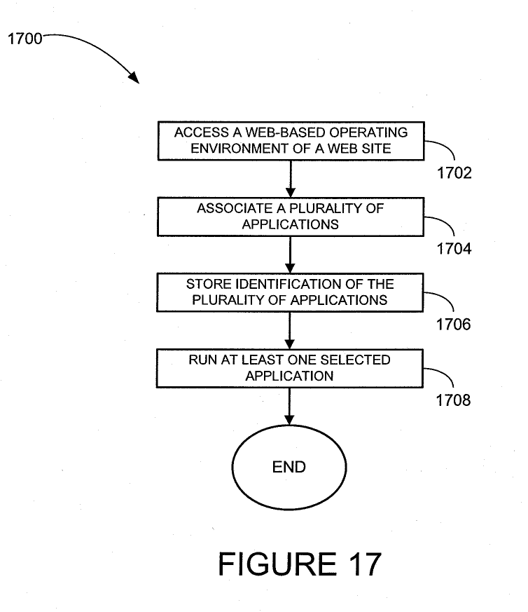

FIG. 17 illustrates a method 1700 for utilizing the web-based operating environment 102 as a platform for a social networking market. The social networking market may include, by way of example, an accounting market, an entertainment market, a legal market, or other type of market.

The web-based operating environment 102 of a web site may be accessed. The web-based operating environment 102 may be capable of being loaded within a single instance of a web browser.

Applications 120 for the web-based operating environment 102 may be associated according to a social networking market at block 1704.

Various domain specific applications may be created and be available for a social networking market. For example, an accountant in an accounting market may have a first set of applications, an attorney in an attorney market may have a second set of applications, and a musician in an entertainment market may have a third set of applications.

The management application 108 may coordinate communication among a remaining portion of the applications 120.

At block 1706, identification of the applications available in the web-based operating environment for the social networking market is stored in the profile 112. The profile 112 may include the applications 120 available to a user for a particular social networking market.

At least one selected application of the applications 120 of the web-based operating environment 102 is run at block 1708. For example, a CD cover design application may be used by a musician to create a CD cover in the web-based operating environment 102.

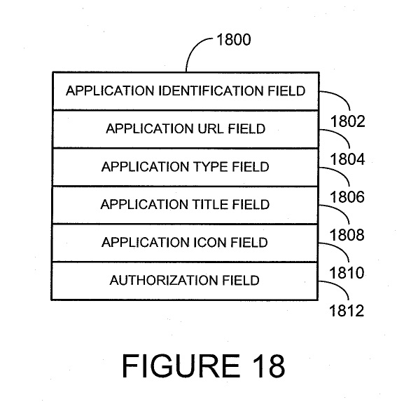

FIG. 18 illustrates a data structure 1800 used to track the application 120 in the web-based operating environment 102 or in another operating environment. The data structure 1800 may be retained in the management application 108 or in another location.

The data structure 1800 may include an application identification field 1802, an application uniform resource locator (URL) field 1804, an application type field 1806, an application title field 1808, an application icon field 1810, and/or an authorization field 1812. Other fields may also be used.

The application identification field 1802 receives an identification of the application 120. The application URL field 1804 receives a link to the application 120. The application type field 1806 receives an indication of the type of the application. For example, the application type may indicate multiple instances of the application 120 may be run in the web-based operating environment 102.

The application title field 1808 receives a title of the application 120. The application icon field 1810 receives an icon used to identify the application 120 in the web-based operating environment 102. The authorization field 1812 receives an identifier of whether a user is authorized to access the application 102.

While various embodiments in this document discuss the launching of applications 118 in application windows 120, the applications 118 may also be loaded directly into the desktop 110. Thereby, various embodiments may be modified to reflect the launching without the application window 120.

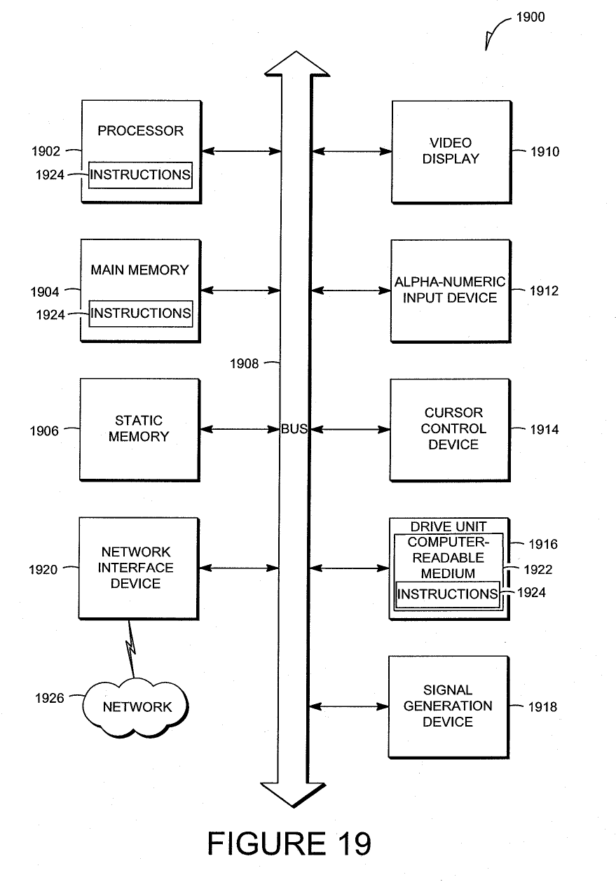

FIG. 19 shows a diagrammatic representation of machine in the example form of a computer system 1900 within which a set of instructions may be executed causing the machine to perform any one or more of the methods, processes, operations, or methodologies discussed herein. For example, the web-based operating environment 102 (see FIG. 1) may be deployed with the computer system 1900.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU) a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alphanumeric input device 1912 (e.g., a keyboard), a cursor control device 1914 (e.g., a mouse), a drive unit 1916, a signal generation device 1918 (e.g., a speaker) and a network interface device 1920.

The drive unit 1916 includes a machine-readable medium 1922 on which is stored one or more sets of instructions (e.g., software 1924) embodying any one or more of the methodologies or functions described herein. The software 1924 may also reside, completely or at least partially, within the main memory 1904 and/or within the processor 1902 during execution thereof by the computer system 1900, the main memory 1904 and the processor 1902 also constituting machine-readable media.

The software 1924 may further be transmitted or received over a network 1926 via the network interface device 1920.

While the machine-readable medium 1922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for web-based operating environments have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a web-based operating environment of a web site, the web-based operating environment loaded within a single instance of a web browser, the web-based operating environment including a plurality of available applications identified by a profile; and
running at least one selected application of the plurality of available applications within the web-based operating environment.

2. The method of claim 1, wherein accessing the web-based operating environment includes:
loading the web-based operating environment within a web page; and
loading the plurality of applications within the web-based operating environment.

3. The method of claim 1, wherein running the at least one selected application comprises:
receiving a selection of at least one application;
identifying the at least one selected application among the plurality of available applications;
accessing the at least one selected application; and
running the at least one selected application within the web-based operating environment.

4. The method of claim 1, wherein running the at least one selected application includes running a plurality of selected applications simultaneously within the web-based operating environment.

5. The method of claim 1, wherein running the selected application comprises:
determining whether an instance of the at least one selected application is already running within an application window of the web-based operating environment;
determining whether multiple instances of the application are allowed to run within the web-based operating environment; and
running the at least one selected application within the web-based operating environment based on determination results.

6. The method of claim 1, wherein running the selected application comprises:
accessing the profile of a user of the web-based operating environment; and
running the at least one selected application of the plurality of available applications within the web-based operating environment based on the profile of the user.

7. The method of claim 1, further comprising:
providing context data from the at least one selected application to at least one available application of the plurality of available applications, the at least one available application capable of utilizing the context data.

8. The method of claim 7, wherein the at least one available application is not running within the web-based operating environment at the time the context data is received by the at least one available application.

9. The method of claim 1, further comprising:
receiving application data from the at least one selected application; and
storing the application data.

10. The method of claim 9, further comprising:
receiving a request for the application data from a user; and
providing the application data to the user client-side.

11. The method of claim 9, further comprising:
receiving a request for the application data from an additional application of the plurality of applications; and
providing the application data to the additional application.

12. The method of claim 1, further comprising:
receiving a profile modification request; and
modifying a profile within the web-based operating environment in accordance with the profile modification request.

13. The method of claim 12, wherein the profile modification includes a request to modify the plurality of available applications available within the web-based operating environment, a portion of the profile to display to other users within the web-based operating environment, user information of a user of the web-based operating environment, or a combination thereof.

14. The method of claim 12, wherein the profile further defines a portion of information and functionality available from the plurality of available applications to other users through the web site.

15. A method comprising:
receiving a launch request for an application of a web site in a web-based operating environment;
creating an instance of an application window in the web-based operating environment;
providing at least one initialization parameter to the instance of the application window;
loading the application in the application window; and
initializing the application within the application window in accordance with the at least one initialization parameter to run the application.

16. The method of claim 15, wherein the at least one initialization parameter includes at least one of a file name or a file ID.

17. The method of claim 15, further comprising:
receiving an adjustment request for adjustment to the application window; and
adjusting the application window in accordance with the adjustment request.

18. The method of claim 17, wherein receiving the request includes:
receiving the adjustment request to the application window;
modifying a recording of a state of the application window in accordance with the adjustment request; and
providing the adjustment request to the application window.

19. The method of claim 17, wherein adjusting includes:
scaling the application window in accordance with the adjustment request.

20. The method of claim 17, wherein an aspect ratio of the application window does not change as a result of scaling.

21. A method comprising:
receiving a notification and at least one parameter from an application running within a web-based operating environment;
identifying the notification as an event; and
broadcasting the event and the at least one parameter to a plurality of applications running within the web-based operating environment of a web site.

22. The method of claim 21, wherein broadcasting includes:
accessing a running applications list of a plurality of application running within the web-based operating environment of a web site; and
broadcasting the event and the at least one parameter to the plurality of applications on the running applications list.

23. The method of claim 21, wherein the at least one parameter includes at least one of an event type, an initialization parameter, a session ID, a user name, or a user type.

24. A method comprising:
receiving a request for application data for an application, the application available within a web-based operating environment of a web site;
sending the request for the application data to a back-end server;
freezing the application and displaying a progress indicator on a desktop available within the web-based operating environment, the frozen application configured to ignore a further received request;
receiving the application data from the back-end server; and
unfreezing the frozen application and removing display of the progress indicator upon receipt of the application data.

25. The method of claim 24, wherein receiving the request further includes incrementing a counter for each item of application data requested, wherein receiving the application data further includes decrementing the counter for each item of the application data received; and wherein unfreezing the frozen application includes:
unfreezing the frozen application and removing display of the loading image when the counter returns to a base number.

26. The method of claim 24, wherein freezing the application further includes:
associating an invisible button with the frozen application, the invisible button configured to receive the further received request.

27. The method of claim 24, wherein the progress indicator includes a loading animation, a loading image, or a combination thereof.

28. A method comprising:
receiving an identification of a target application and at least one target parameter, the target application within a web-based operating environment of a web site;
determining whether an instance of the target application is running in the web-based operating environment;
creating a new instance of the target application based on a result of the determination; and
providing the at least one target parameter to the target application based on the result of the determination.

29. The method of claim 28, wherein determining whether the instance comprises:
determining whether the target application is configured to have multiple instances running in the web-based operating environment.

30. The method of claim 28, wherein providing the at least one target parameter comprises:
providing the at least one target parameter to the new instance of the target application.

31. The method of claim 28, wherein providing the at least one target parameter comprises:
providing the at least one target parameter to an existing instance of the target application.

32. A method comprising:
receiving a drag request for an item on a desktop within a web-based operating environment, the item associated with an item type;
displaying a drag image for the item following a mouse cursor displayed on the desktop;
identifying a target application associated with a drop request; and
providing a plurality of parameters to the target application associated with a drop request, the target application capable of evaluating the item based on at least one of the plurality of parameters to determine a reaction.

33. The method of claim 32, wherein displaying the drag image further comprises:
tracking a plurality of parameters of the item in the web-based operating environment, the plurality of parameters including the item type.

34. The method of claim 32, wherein the web-based operating environment is of a web site.

35. A method comprising:
accessing a web-based operating environment of a web site, the web-based operating environment capable of being loaded within a single instance of a web browser,
associating a plurality of applications for the web-based operating environment according to a social networking market; and
storing identification of the plurality of applications available in the web-based operating environment for the social networking market in a profile.

36. The method of claim 35, further comprising:
running at least one selected application of the plurality of applications of the web-based operating environment.

37. The method of claim 35, wherein the social networking market includes an accounting market, an entertainment market, a real estate market, a health services market, or a legal market.

38. The method of claim 35, wherein the web-based operating environment includes a management application, the management application configured to coordinate communication among the plurality of applications.

39. A machine-readable medium comprising instructions, which when implemented by one or more processors perform the following operations:
access a web-based operating environment of a web site, the web-based operating environment loaded within a single instance of a web browser, the web site including a plurality of available applications identified by a profile; and
run at least one selected application of the plurality of available applications within the web-based operating environment.

40. The machine-readable medium of claim 39 comprising instructions, which implemented by one or more processors perform the following additional operations:
provide context data from the at least one selected application to at least one available application of the plurality of available applications, the at least one available application capable of utilizing the context data.

41. The machine-readable medium of claim 39 comprising instructions, which implemented by one or more processors perform the following additional operations:
receive a profile modification request; and
modify a profile within the web-based operating environment in accordance with the profile modification request.
